(19) United States
(12) Patent Application Publication
(10) Pub. No.: US 2002/0184157 A1
(43) Pub. Date: Dec. 5, 2002

(54) Method and apparatus for registering a usage value of commodity

(75) Inventor: Dieter Pauschinger, Berlin (DE)

Correspondence Address: SCHIFF HARDIN & WAITE, 6600 SEARS TOWER, 233 S WACKER DR, CHICAGO, IL, 60606-6473, US

(73) Assignee: Francotyp-Postalia AG & Co. KG

(21) Appl. No.: 10/090,997

(22) Filed: Mar. 5, 2002

(30) Foreign Application Priority Data
Mar. 29, 2001 (DE) 101 16 703.2

(51) Int. Cl. G06F 17/60

(52) U.S. Cl. 705/52

(57) ABSTRACT

In a method and a usage counter for registering a usage value of a commodity, a measured value of the commodity is generated between an input and an output for the commodity, a rate value for charging for usage of said commodity is non-volatilely stored, and in a security module a monetary charge is calculated from the measured value and the rate value. A communication device communicates the calculated monetary charge to a location remote from the usage counter in a secured communication. The security module generates an electronic reaction to attempts to fraudulently manipulate the calculated monetary charge, such as by breeching the security of the security module, or by unusual deviations in the measured value of the commodity.

### BACKGROUND OF THE INVENTION

1. Field of the Invention

The present invention is directed to a method for registering a usage value of a commodity as well as to a usage counter for tracking use of a commodity, which are suitable for use in an environment wherein falsification of the degree of usage of the commodity may occur.

2. Description of the Prior Art

In mail processing wherein high security against tampering is required, cryptographic security measures are already utilized in a debiting of frankings and in the generation of a unique marking for each franking imprint.

U.S. Pat. No. 5,953,426 discloses a specific secret key method for this purpose. The secret key is stored in a secure data bank at a verification location, typically at the postal authority, and is thus kept secret. A data authentication code (DAC) is formed from the data in a message to be communicated, this data authentication code being converted into a marking symbol row that can then be employed as a digital signature for an authentification check of the message. The data encryption standard (DES) algorithm disclosed by U.S. Pat. No. 3,962,539 is also applied. The latter is the best known symmetrical crypto-algorithm. Using a symmetrical crypto-algorithm, a message authentification code (MAC) can be generated for data of the aforementioned DAC or for messages, such codes being employed for authentification checking. In a symmetrical crypto-algorithm, the advantage of a relatively short MAC is opposed by the disadvantage of a single secret key.

The advantage of an asymmetrical crypto-algorithm is the ability to employ a public key. A known asymmetrical crypto-algorithm is the RSA algorithm, named after its inventors R. Rivest, A. Shamir and L. Adleman and having been disclosed by U.S. Pat. No. 4,405,829. As is known, the receiver uses a private secret key to decipher an encrypted message that was encrypted with a public key at the transmitter. The receiver keeps this private key secret but sends the appertaining public key to potential dispatchers. RSA was the first asymmetrical method that was suitable for the communication of keys as well as for the production of digital signatures.

Digital signatures can likewise be generated with the private key, whereby the public key serves for the authentification of the signature. RSA, as well as digital signature algorithms, use two keys, one of the two keys being public. The key utilization thereby ensues in the reverse sequence. The implementation of the RSA algorithm in a computer, however, results in extremely slow processing and produces a long signature.

A digital signature standard (DSS) has been developed that produces a shorter digital signature and that includes the digital signature algorithm (DSA), according to U.S. Pat. No. 5,231,668. This development ensued proceeding from the identification and signature according to U.S. Pat. No. 4,995,085 and proceeding from the key exchange according to Diffie-Hellman, (U.S. Pat. No. 4,200,770) or from the ElGamal method (El Gamal, Taher, “A Public Key Cryptosystem and a Signature Scheme Based on Discrete Logarithms”, 1III Transactions and Information Theory, vol. IT-31, No. 4, July 1985). In an asymmetrical crypto-algorithm, the advantage of the employment of a public key is countered by the disadvantage of a relatively long digital signature.

U.S. Pat. No. 6,041,704 discloses a modified public key method for producing a shorter signature, but an extraordinary long data processing time can be avoided with this method only by using extremely fast processors. In order to protect the secret private key against theft from a computer or from a postage meter machine, a security region must be created, since the entire security of the signature is based on that the private key not becoming known. The public key, in contrast, could be employed in a number of postal institutions for checking the signature. Such a security region is created in devices with a component known as a security module. It is disadvantageous that the security module must exhibit high computing power in order to execute the data processing in real time or within a justifiable time span.

The data processing of a hash function, in contrast, is even two through four orders of magnitude faster then the data processing of the digital signature or of the asymmetrical encryption. The formation of a checksum is a very simple example of a hash function. The byte sequence of information stream is compressed to form a hash value that differs from other hash values that were formed from other information. With the one-way hash functions used in cryptogography, it is nearly impossible to form a different byte sequence that yields the same hash value, so that these one-way hash functions generally can be considered not to be reversible. A one-way hash function developed by Ron Rivest in 1991 has a hash value is 128 bits long, but which is not as secure as the MD160 or SHA (secure hash algorithm). These latter two employ a 160 bit has value. The SHA was developed by the NIST with the collaboration of the NSA and was published in 1994. The SHA is a component of the digital signature algorithm (DAS). The registrations that are collected can be shipped or sent for inspection to a third location. A message authentication code (MAC) could be attached to every individual registration. This requires centrally storing a secret key that is unique for each security module.

A security module (see European Applications 1 035 513, 1 035 516, 1 035 512 and 1 035 518) that uses a symmetrical crypto-algorithm has been employed in a postage meter machine of the JetMail® type, manufactured by Francotyp-Postalia AG & Co. KG. A key transmission between the security module and a data center ensues with a DES-encrypted dataset that is also MAC-protected. The cryptographic calculation, however, is only one of the security measures in a debiting of services and calculation of a charge for the vending of services as well as in a communication of the debiting result or the accounting to a remote data center. A security module must also be able to survive a physical or chemical attack. Such an attack, moreover, can be detected and registered.

U.S. Pat. No. 4,812,965 discloses a system for remote inspection of a device that reduces the requirement for a local inspection. Every tampering act or attempt is registered by the device and is communicated to a central station. This solution, however, does not protect against attacks such as the so-called “man in the middle attack” that are started when information is sent via modem to the central station.

European Application 504 843 corresponding to U.S. Pat. No. 5,243,654 discloses a charge acquisition system having a time limit that can be remotely reset and having a device that is equipped for emitting a signal representing a commodity (energy), whereby the user of the device is forced to regularly inform the data center of the status of the accounting register before the expiration of the time limit. A disadvantage is that no security module is present and that a user must enter a combination into the device.

A seal or a lead medallion at the commodity usage counter is the sole security measure. Given an evasion of this security measure, the registration of the usage value can be manipulated with fraudulent intent. As a result of such manipulations, the (energy) supply companies regularly lose a large amount of money. Whereas industrial customers are offered the possibility of legally saving money with favorable fee schedules, small-scale customers are offered no stimulus to use reduced fee schedules. Obviously, the energy is more expensive or the service is more difficult to provide at peak times of consumption, for which, of course, the customer of the service or supply company is appropriately billed.

### SUMMARY OF THE INVENTION

An object is to provide a method for registering a usage value with high protection against falsification that allows the customer to implement a charge debiting in a simplified or cost-saving fashion and that is suitable for a secure communication with a remoter server of the service or supply company.

Another object is to provide a usage counter with a measurement transducer, with which a determination can be made when manipulations are carried out at the usage counter. By means of a number of different, temporarily valid rate schedules, the small-scale customer should also be allowed to save money. The local outlay should thereby be as low as possible.

The above objects are achieved in accordance with the invention in a method and apparatus wherein a usage counter is equipped with a security module and with a communication arrangement, the latter allowing an automatic and protected communication with a remote server of the service or supply company. A usage counter is a device with input and output of a commodity such as material, energy or information which determines an accountable quantity for the commodity passing therethrough. A security module is a registration module equipped with security means for the crediting or debiting of an output charge and for the formation of a message about the aforementioned registration. The determination of the accountable quantity such as, for example, the energy in an energy meter requires an analog-to-digital conversion of at least one analog measured quantity and a calculation according to a first mathematical algorithm. The security module is equipped with an internal A/D converter and with a microprocessor that is programmed for calculation according to the first mathematical algorithm. The calculation of an output charge that is dependent on service or usage value ensues in a real time and in a temporally distinguishable way. Thus, for example, rate schedules can be different for day and night, work days and weekends, summer and winter. The security module is equipped with an internal, battery-supplied real-time clock and with a debiting unit, for example a hardware debiting unit. After debiting the output charge according to the applicable rate schedule in conformity with the use duration and the actual time, a formation of a message ensues for registering at least the output charge. In addition to containing the output charge, the registration can contain the use, the appertaining rate schedule, the use duration and the current time. Securing the registration with an authentification code preferably ensues at the end of every time segment of the use duration.

The time segments are formed periodically and/or event-based. The security module is programmed for calculation of the authentification code according to a first cryptographic algorithm. The security module is equipped with a watchdog timer that regularly enables the communication arrangement for a communication with the remote server. A failed communication attempt is repeated at time intervals until a connection is achieved or until a credit frame has been exceeded. In the latter instance, the usage counter is blocked for the output of usage values. The server monitors whether a message has been received from the usage counter of the customer within the anticipated time frame and as to whether this message is authentic. The message contains encrypted data that are additionally secured with a digital signature and that are encrypted with the microprocessor according to a second cryptographic algorithm and are signed according to a third cryptographic algorithm. The microprocessor monitors whether manipulations were carried out at the usage counter or at the security module. For example, a sensor is provided for determining whether the usage counter was illegally disconnected or bridged via a bypass. The message to the server contains correspondingly protected sensor data. The server can block the output of the usage value in an evaluation of the communicated data.

An asymmetric encryption method is utilized as the second cryptographic algorithm for the message in order to exchange an encrypted dataset with output or usage values, time data, sensor data, available keys and similar data. For example, the RSA method is suitable, whereby a dataset is encrypted at the sending party with a public key of the receiver. A deciphering of the encrypted dataset ensues at the receiver with the appertaining private key of the receiver.

A digital signature based on the third cryptographic algorithm ensues, for example, with the reversed RSA method, whereby a hashed dataset at the sending party is encrypted with a private key of the sending party and is deciphered at the receiver with the appertaining public key of the sending party. The hashed dataset recovered in the above way is compared to a hashed comparison dataset. The comparison dataset is generated at the receiver from the encrypted dataset by deciphering and applying the same hash function. Given coincidence of the recovered, hashed dataset with the hashed comparison dataset, the message received from the server is considered authentic and the communicated values are stored.

### DESCRIPTION OF THE DRAWINGS

FIG. 1 Illustrates a known RSA method.

FIG. 2 Illustrates a signing method using RSA.

FIG. 3 Illustrates the key exchange.

FIG. 4 Illustrates a system for cryptographically secured communication in accordance with the invention.

FIG. 5 Illustrates a usage counter in accordance with the invention.

FIG. 6 is a block circuit diagram of an energy use meter in accordance with the invention.

FIG. 7 is a block circuit diagram of a security module in accordance with the invention.

### DESCRIPTION OF THE PREFERRED EMBODIMENTS

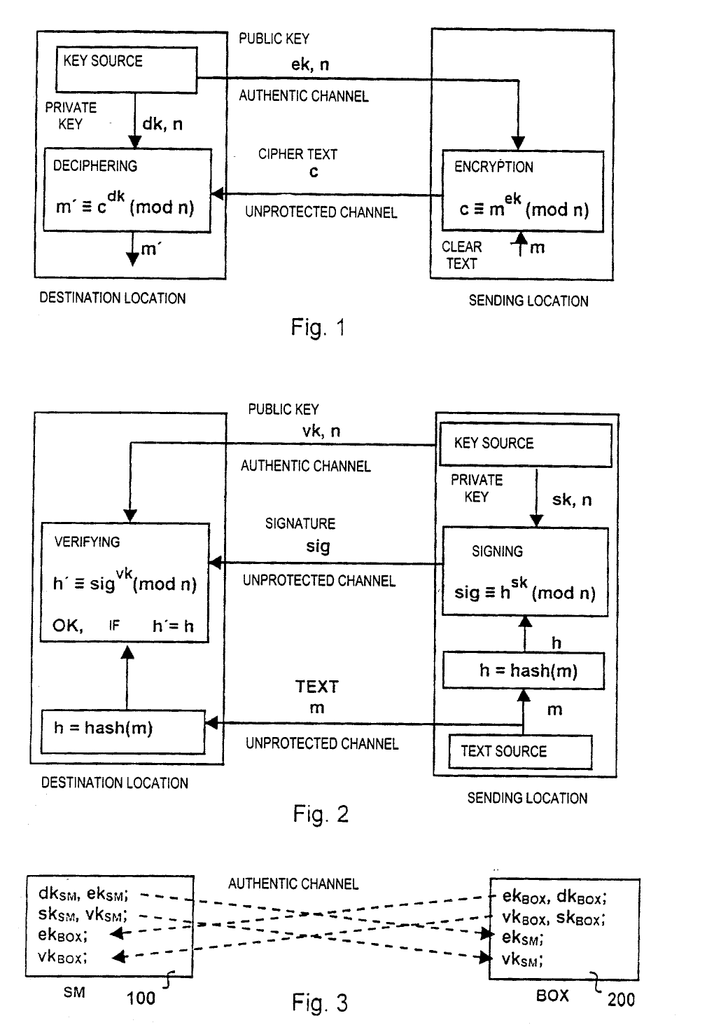

FIG. 1 is a flow chart of a public key method with reference to the example of RSA. The application of asymmetrical encryption algorithms (RSA, ElGamal) requires the generation of a key pair:

(ek,dk)←genKey(k). (1)

The encryption key ek is public and an encryption key dk is private. The public encryption key ek is communicated to the subscriber at the transmission location of a message. Using, for example, a protected channel or a certificate, it is thereby to be assured that the public encryption key is not exchanged between destination location and sending location and misused in a “man in the middle attack”. A mathematical operation is provided for the encryption of the message m at the sending location to form the ciphered text c:

c←encrypt (ek, m) (2)

Modular arithmetic or congruence calculation is utilized in RSA. Two natural numbers a and c are called congruent modulo n when a and c leave the same remainder given a division by n. a=m^{ek} is set and the following, for example, is obtained: c≡m^{ek} (mod n).

The ciphertext c can now be communicated to the destination location via an unprotected channel. An operation is provided for deciphering of the ciphertext c:

m←decrypt(dk, c) (3)

The second participant at the destination location deciphers the ciphertext c with the private deciphering key dk to form the message: m′≡c^{dk} (mod n). According to the laws of modular arithmetic, the latter agrees with the original message m when m′ and c^{dk} have a congruent modulo n. The following thus applies: m=m′.

FIG. 2 is a flow chart of a signature method with reference to the example of RSA. The application of digital signature mechanisms (RSA, DSA or ECDSA) likewise requires the generation of a key pair. First, a public ratification key vk, n is communicated to the second participant at the destination location, for example secured via a protected channel or a certificate. A signature key sk remains as the private key of the security module at the sending location of a first participant and the verification key vk is provided as public key for evaluating digital signatures sig that are allocated to a message m (=message). The message m and the signature can now be communicated via an unprotected channel to the second participant at the destination location. A mathematical operation is provided for generating a signature sig with the security module at the sending location of a first participant:

sig←sign(sk, m) (4)

For reducing the length of a signature sig, a hash function is first applied to the message m:

h=has(m) (5)

A private signature key sk of the security module and, for example, modular arithmetic or congruence calculation are again utilized for finding at the sending location of a first subscriber:

sig≡h^{sk} (mod n) (6)

For verification of a signature sig at the destination location, a public verification key vk, the unencrypted message m and a mathematical operation of the following species are provided:

acc←verify(vk, m, sig) (7)

whereby the result can be true (valid) or false (invalid). Before the checking, a hash function is applied to the message m:

h=hash(m) (8)

At the destination location, the second participant uses the public verification encryption key vk to verify the signature sig for the has value h′, which, according to the laws of modular arithmetic, agrees with the hash value h formed from the original message m when h′ and sigvk are congruent modulo n. The following thus applies:

h=h′≡sig^{vk} (mod n) (9)

For h≠h′, the signature sig or message m is considered non-authentic but is otherwise considered authentic h=h′.

Each communication participant is equipped with a security module or with a security box that exchanges public keys via a protected channel before the communication wherein a communication of messages ensues. This preferably is carried out at the seller or dealer of the security module or at the manufacturer.

The key exchange between a security module 100 and a security box 200 is explained in greater detail on the basis of the illustration shown in FIG. 3. First, key pair are respectively generated in both. The security module 100 generates a public encryption key ek_{SM} and a private encryption key dk_{SM}. The security module 100 also generates a public verification key vk_{SM} and a private signature key sk_{SM}. The security box 200 generates a public encryption key ek_{BOX} and a private encryption key dk_{BOX}. The security box 200 also generates a public verification key vk_{BOX} and a private signature key sk_{BOX}. The public keys are communicated to the respective communication participant. The public encryption ek_{BOX} and the public verification key vk_{BOX} are communicated from the security box 200 to a security module 100 and are stored thereat. The public encryption key ek_{SM} and the public verification key vk_{SM} are communicated from the security module 100 to the security box 200 and are stored thereat.

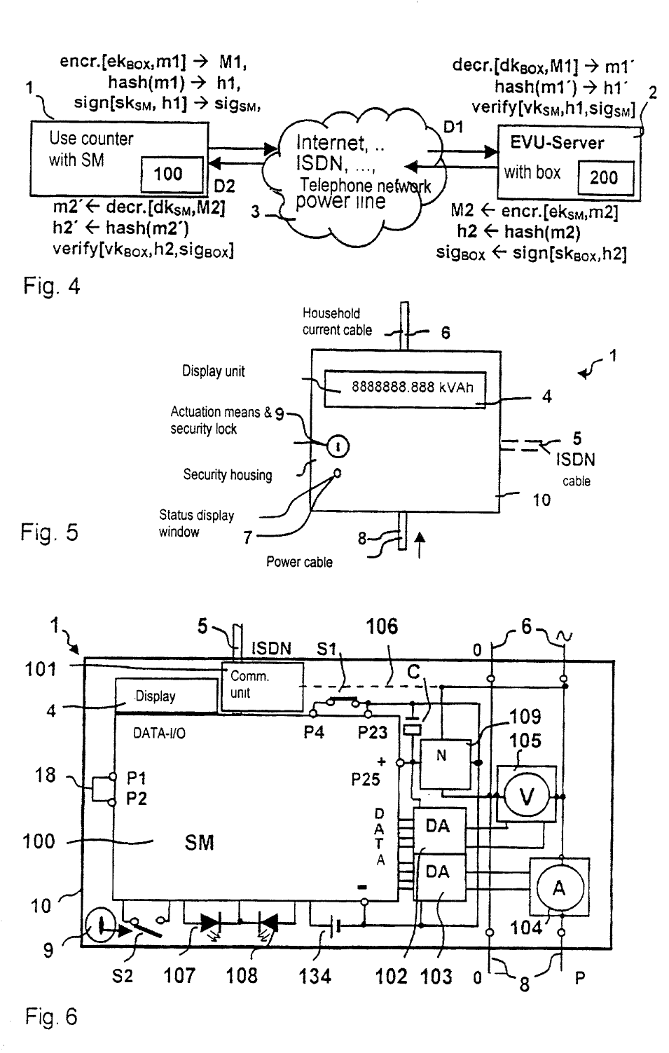

FIG. 4 shows an illustration of the system for a cryptographically secured communication via an unprotected channel. The usage counter 1 is connected to the EVU server 2 via ISDN, DECT telephone, Internet, power line or some other network. The usage counter 1 has a security module 100 that is equipped for the encryption/decryption of a message m with a public encryption key ek_{BOX} of the security box 200. A ciphertext M1 is first formed according to a second cryptographic algorithm based on the equations (2) or (5), and a hash function is applied to the message m, whereby the hash values h1←hash(m) arises. The security module 100 forms a signature sig_{SM}←sign[sk_{SM},h1] according to a third cryptographic algorithm based on the equations (4) and (5). The ciphertext M1 and the digital signature sig_{SM} are communicated as dataset D1=M1, sig_{SM} to the security box of the EVU server 2. The EVU server 2 uses its private decryption key dk_{BOX} to decipher the ciphertext M1 to form the message m1 and checks the authenticity thereof on the basis of the signature. The EVU server 2 generates a message m2, communicates the message encrypted to form the ciphertext M2 in a dataset D2 to the security module. The message m2 cn include n enable code for the user counter 1. The message m1 contains use and accounting data or output values and debiting values, time data among other data. It can be interpreted further by the EVU server 2 in order to generate a debit corresponding to the valid rate schedule. The dataset D2 communicated to the security module 100 likewise contains a ciphertext m2 and the digital signal signature sig_{BOX}. The authenticity of the enable code can be verified with the latter. Upon reception of the cryptographically secured enable code in the form of a second dataset D2, a registration of the change occurs by resetting the output charge to zero when the enable code was authentic. Otherwise, the usage counter 1 is inhibited.

FIG. 5 shows a illustration of a usage counter 1, for example a current or energy meter. In the embodiment of an energy meter, the usage counter 1 is connected between a power cable 8 and a household current cable 6 and is equipped with a display unit 4 for showing energy consumption. A security housing 10 of the usage counter 1 is equipped with a security lock 9. The usage counter 1 in this embodiment further has a window 7 for an additional status display of the security module (not visible) and an optional cable 5 for a communication connection to the EVU server 2, for example via an ISDN telephone network.

FIG. 6 shows a circuit diagram of the usage counter 1 in the aforementioned embodiment of an energy meter. This can replace a standard household meter (induction meter for single-phase AC current with a Ferraris measurement unit). A switch S1 that is opened when the security housing 10 is opened can be connected to the security module 100 for detecting a manipulation. The status display with LEDs 107, 108 indicates an unauthorized opening even after the security housing 10 has been closed again. At the hardware side, a trigger switch S2 is connected for the resetting. The switch 52 is triggered into a second switch position, for example, given switching of the security lock 9. A resetting of the status of the security module 100 is allowed only by an authorized inspector who has a corresponding key and triggers a communication with the EVU server 2 in order to report or communicate the inspection. Commercially obtainable measurement transducers 104, 105 for current or voltage measurement respectively deliver analog measured signals i(t), u(t) after full-wave rectification that is converted by D/A converters 102, 103 into digital signals that are supplied to the data inputs of the security module 100. The momentary values of the rectified voltage u(t), for example, across a load resistor R, or that arises given a load current i due to a magnetic induction for an inductance L [u(t)=L·di/dt], are sampled by the microprocessor of the security module 100 (using a multiplexer when two data inputs must be sampled in alternation). After sampling the data inputs a digital multiplication of the measured signals u(t)·i(t) is made and a summation ensues for every half-period T/2 of the single-phase AC current. The effective power P in the time range Δt=x·T derives as a result of this momentary value multiplication together with accumulated storage of the sums of the amounts. The respective momentary values are added in a non-volatile memory, and the stored result or a momentary value can be displayed. Corresponding data outputs of the security module 100 are provided for the display unit 4. Let t1 be the beginning and t2 be the end of the time range Δt₁=t2−t1 that includes a number x of periods T, with a first rate being applicable for the debiting of an output charge F1. Further, let t3 be the beginning and t4 be the end of a second time range Δt₂=t4−t3 that likewise includes a number x of periods T, with a second rate being valid for the debiting of an output charge F2. Given an event such as a change in the rate or load, the microprocessor implements a calculation of the output charge according to the appertaining tariff in conformity with the use duration and implements storage in separate memory areas of the non-volatile memories together with the respectively appertaining, current usage value V_{K}. A further storage of use data can ensue in order to determine the user behavior or in order to derive marketing data.

The security module 100 identifies an event V_{K} at time tⱼ that must be registered at least as a real-time message. Further data are added thereto, for example, a rate-dependent output charge. Such data elements are, for example:

| | |
|---|---|
| #K: | Sequence counter (‘13’), |
| R: | Type designator of the message (‘R’ for realtime), |
| V1_{K}: | Consumption and use data (‘daily use, Mr. Pauschinger’), |
| F1_{K}: | Output charge according to a first rate (‘daily use charge’), |
| V2_{K}: | Consumption and use data (‘night use, Mr. Pauschinger’), |
| F2_{K}: | Output charge according to a second rate (‘night use rate’), |
| tⱼ: | Current real-time value with fixed length (decimalized: |
| | ‘8491028108032001’), |
| A_{K}: | Authentification code (decimalized: ‘8023024892048398’), |
| | i.e. signature, typically with fixed length. |

In a first step before the first cryptographic operation, a compilation of a “real-time” message V1_{K}, F1_{K}, V2_{K}, F2_{K}, tⱼ with further data #K, R ensues for forming a dataset:

INPUT=#K, R,V1_{K}, F1_{K}, V2_{K}, F2_{K}, tⱼ (10)

For example, let #K=13 for a 13 registration:

INPUT=′13R daily-consumption, Mr. Pauschinger daily use charge Night consumption, Mr. Pauschinger night -use charge 8491028108032001

In the second step, a calculation of the authentification code A_{K} ensues from INPUT by forming the hash value:

A_{K}←hash (INPUT) (11)

For example:

A_{K}=‘8023024892048398’.

In the third step, the resultant authentification code A_{K} is attached to the real-time message. At time tⱼ, thus, the message m1 with the message to be stored thus reads:

m1=#K, R, V1_{K}, F1_{K}, V2_{K}, F2_{K}, tⱼ, A_{K}

with

K=13 (12)

A registration includes storage of real-time data and charge data. Transmission of a dataset D1 from the security module 100 at the transmitting location to a security box 200 of an EVU server 2 at the destination location ensues periodically.

For preparing for generating a digital signature, the message m1 is hashed:

h1←hash(m1) (13)

A public encryption key ek_{BOX} of the box and a private signature key sk_{SM} of the security module 100 are present stored in non-volatile form in the security module 100. A program stored in the internal program memory programs the microprocessor of the security module 100 to operate as an authentification machine. The digital signature is formed with the signature key sk_{SM} of the security module 100:

sig_{SM}←sign[sk_{SM}h1] (14)

For preparing for the communication of the message to the server 2, the microprocessor of the security module 100 encrypts the message m1 with the encryption key ek_{BOX} of the security box to form the ciphertext M1:

M1←encrypt[ek_{BOX}, m1] (15)

The dataset D1 to be communicated reads:

D1=M1, sig_{SM} (16)

Each usage counter 1 contains a communication unit 101 for communication with the server 2, that contains a comparable communication unit (not shown). A private encryption key dk_{BOX} of the box 200 and a public verification key vk_{SM} of the security module 100 are present in the security box 200 of the server 2, stored in non-volatile fashion. A program stored in the internal program memory programs the microprocessor of the security box 200 to operate as a verification machine. The server 2 operates adapted to the respective type and nature of the generation of the registration. Accordingly, the registration current called by the server 2 from the security module 100 is analyzed is dependent on the corresponding application.

FIGS. 5 and 6 show an ISDN cable 5 connected to the usage counter 1. In an exemplary embodiment the communication device 101 is a modem, preferably an ISDN module, that is communicatively connected to the server 2 via a telephone/ISDN network. Given communication of the usage counter 1 with the EVU server 2 to directly via ISDN network, a corresponding communication unit 101 can be supplied with energy from the telephone/ISDN network or can be supplied with energy via a line 106 from the power pack or by the household current cable 6.

Alternatively, it is possible to use a digital power line service of the energy supply company (EVU). The communication device 101 is then a power line module that is communicatively connected to the server 2 via an energy supply network. The power line module is correspondingly fashioned to transmit a message with transmission rates up to 1 Mbit/s via a line 106 via power cable 8 to the EVU server 2. The existing power supply cables are thereby employed as physical carrier medium for a communication network. Of course, the aforementioned ISDN cable 5 is then eliminated.

Another alternative for avoiding cable connections is offered by a 2.4 GHz blue tooth radio receiver/transmitter module that is utilized as communication device 101. The communication device 101 can be integrated in the security module 100. A blue tooth module, that should be wirelessly in communication with the server 2 via a further blue tooth module, can only communicate with an identical blue tooth module over relatively short distances, for example, 10 m, so that the latter must still be connected to an ISDN terminal device. The further blue tooth module is thus in turn communicatively connected to the server 2 via a telephone network. For example, the ISDN network is again used.

The security module 100 can be supplied with energy from the energy network via the household current cable 6 or the power cable 8. To that end, a power pack 109 is required that is preferably connected such that the power customer bears the cost thereof. The ground terminal at pin P23, for example, is at the negative voltage potential and the operating voltage terminal at pin P25 is at the positive voltage potential. An electrolytic capacitor C buffers the operating voltage. A conductor loop lies at the terminals P1, P2, and extends over the entire security housing and must be broken in the case of destruction of the security housing 10. The usage counter 1 has a security housing 10 that surrounds the security module 100, a display unit 4, a delivery and output device 8, 6 and a communication device 101. The security module 100 is connected to at least one measurement transducer 104, 105, to the display unit 4 for displaying a usage value as well as to the switches S1, S2, and the loop 18. The security module 100 has a non-volatile memory 124, 129 for storing temporarily valid rate schedules and is programmed to calculate an output charge based on the usage value dependent on rate and to react to a response of the switches S1, S2, and the loop 18 as well as the values of the measurement transducers 104, 105 that signal a manipulation with fraudulent intent. The security module 100 contains an internal lithium battery 134 for data preservation of the non-volatilely stored data in order to enable an emergency supply given an energy outage. In addition to the cumulative power, the non-volatilely stored data additionally store the time, so that the separation from the energy supply network can be subsequently distinguished from a voltage outage in the energy supply network. In the absence of system voltage, the security module 100 simply switches to the emergency supply via battery 134.

The security module 100 functions as a voltage watchdog in order to check whether the counter was disconnected or not. The usage counter 1 has at least one analog/digital converter 102, 103 that is connected to the at least one measurement transducer 104, 105. Alternatively, the security module 100 has an integrated analog/digital converter 127 that is connected to the measurement transducers 104, 105. The security module 100 has a real-time counter 122, and the security module 100 functions as a watchdog timer in order to regularly communicate counter readings to the server 2. Since the security module 100 contains the real-time counter 122, the microprocessor of the security module 100 can access temporarily valid rate schedules that are stored in the non-volatile memory. The micro-processor of the security module 100 is programmed to calculate an output charge in rate-dependent fashion based on the usage value.

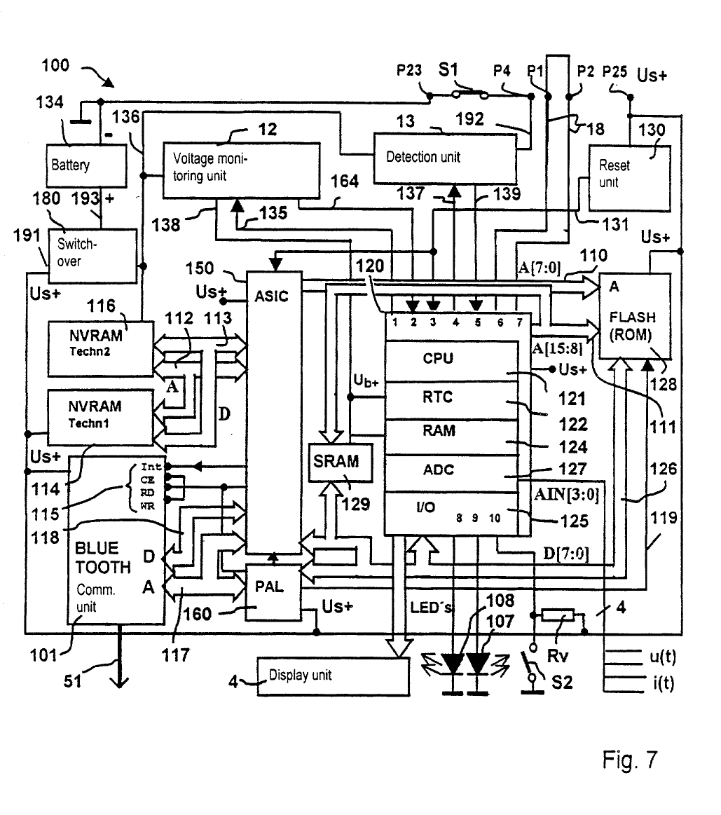

FIG. 7 shows a block circuit diagram of an embodiment of the security module 100. Given unauthorized opening of the security housing and/or removal of the security module 100, the switch S1 is actuated and a detection unit 13 stores the event in non-volatile fashion. Given damage to the security housing 10, for example as a result of drilling into the security housing, a conductor loop 18 connected to the pins P1 and P2 is opened, pulses that can be temporally allocated being communicated thereover in the closed condition. The microprocessor receives the transmitted pulses for the purpose of analyzing the detection data to determine whether damage or manipulation at the security housing 10 has occurred. A proper opening/closing of the security housing 10 is detected with the trigger switch S2. The switches S1, S2 and the conductor loop 18 lie at inputs/outputs of an input/output interface 125 of the microprocessor 120.

The type S3C44A0X of Samsung is suitable as suitable as the microprocessor 120. This has additional analog inputs for analog values u(t), i(t), an internal multiplexer (not shown) and an internal AD converter 127, so that separate AD converters can be eliminated. Four lines for the analog values u(t), i(t) are connected to the analog inputs. Moreover, an external LCD display 4 connected to the input/output interface 125 is supported with the integrated LCD controller (not shown). External light emitting diodes 107, 108 for status display are connected to the input/output interface 125. The status of the security module 108 can be signaled by a bi-color light-emitting diode instead of the light-emitting diodes 107, 108. A status message can include further data elements, for example:

detection data of a manipulation at the housing,

detection data of a manipulation at the security module,

version number and validity date of the rate schedules.

peak load and time of day of the peak load,

next communication deadline, etc.

The 60-bit general purpose I/O ports make adequate input/outputs available at the microprocessor 120 in order to directly connect a communication unit 101 and further I/O means. Preferably, however, adaptation logic in the form of the ASIC 150 and of the programmable logic 160 is connected between microprocessor 120 and communication unit 101. The communication unit 101 can be integrated into the security module 100 and may be implemented as an ASIC. Modern digital communication technology, for example a blue tooth module, is suitable for this purpose. The latter transmits at a power of approximately 1 mW via a short antenna 51. The integrated real-time clock (real-time counter) 122 of the microprocessor 120 clocks the communication in addition to the above-described security functions. The security module 100 of respective usage counters of different customers can be programmed to communicate on different days, so that not all of them call the server simultaneously.

The EVU server 2 communicates new, current rate schedules, including version number and validity date of the rate schedules, for the purpose of storing in the security module. To this end, the microprocessor has an internal RAM 124 that is battery-supported. If the RAM 124 is inadequate, a further battery-supported SRAM 129 can be integrated into the security module 100 and operates in addition to the RAM 124 of the microprocessor 120 for the purpose of non-volatile storing rate schedule values that are valid in prescribed time spans. The integrated real-time clock 122 supplies real-time data. The microprocessor 120 assumes the analysis of time data for rate-dependent determination of at least one usage value. Given predetermined events, a CPU 121 of the microprocessor 120 accesses the temporarily valid rate schedule in the SRAM 129, which hands over the data for the output charge to a data processing unit fashioned as the ASIC 150. The debiting ensues via the ASIC 150 into the non-volatile memories NVRAM 114, 116. For security reasons, two different storage technologies are utilized for the two NVRAM s. For debiting, formation of a message that includes the usage value, the output charge and the time data, formation of a check code and securing of the message with the check code, ensue at event-defined and time-defined time intervals. The check code is calculated by the CPU of the microprocessor 120. The ASIC 150 undertakes a formation and registration of a message m1 that contains the message and the check code. In another version, the microprocessor 120 can assume tasks of the ASIC 150. The securing of the registration of the use preferably ensues at the end of each time segment of the use duration, the time segments being formed periodically and/or event-based. For example, an event is a change in rate schedule or load.

At longer time intervals, the microprocessor 120 implements a cryptographic securing of a message and a communication to the remote server 2 for communicating the cryptographically secured message in the form of a first dataset D1. The security box 200 of the server 2 verifies and deciphers the message. Only when a verification yields the authenticity of the message does the server 2 generate an enable code. The security box 200 of the server 2 can secure the enable code by encryption and signature. The security module 100 of the usage counter 1 can verify the authenticity of the enable code on the basis of the signature of the server 2. Upon reception of the cryptographically secured enable code, a registration of the change of the output charge ensues by resetting to zero if the enable code is authentic, and a blockage of the output of an accountable quantity or of the use of a usage value is undertaken when the enable code is not authentic.

As the usage counter 1, solid, liquid or gaseous quantities require specifically adapted meters that are likewise equipped with the security module 100 in the inventive way. The usage counter 1 also can be a postage meter machine. The accountable quantity is then the franking value. Further details about assemblies of the security module for such a purpose are disclosed in European Applications 1 035 513, 1 035 516, 1035 517, 1 035 518, and German Utility Model 200 206 35. The analysis of the monitoring functions and cryptographic calculations ensues in the microprocessor. The first cryptographic algorithm for generating the authentification code for registration data is, for example, a hash function. Of course, a check sum or a MAC formed according to a symmetrical encryption algorithm can also be used instead of the authentification code. Of course, the debiting function of the ASIC 150 can be assumed or checked by the microprocessor 120.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for registering a usage value, representing use of a commodity, comprising the steps of:
non-volatilely storing at least one rate value for usage of a commodity, said rate value being valid within a predetermined time span;
obtaining respective measured values, using a mathematical algorithm, representing delivery of said commodity to a use location and output of said commodity from said use location;
obtaining time data relating to usage of said commodity at said use location and generating at least one usage value representing usage of said commodity at said use location, from said time data and said measured values;
generating a monetary charge for said usage of said commodity at said use location from said usage value and said rate value;
generating an electronic message that includes at least said charge;
forming a check code for protecting said electronic message;
generating a protected message that contains said electronic message and said check code; and
establishing electronic communication with a recipient at a location remote from said use location and electronically transmitting said protected message as a dataset to said recipient.

2. A method as claimed in claim 1 wherein the step of establishing said electronic communication with said recipient comprises making an initial attempt to establish said electronic communication with said recipient and, if said initial attempt is unsuccessful at establishing said electronic communication, repeatedly attempting to establish said electronic communication with said recipient until expiration of a predetermined limit.

3. A method as claimed in claim 1 wherein said dataset is a first dataset, and comprising the additional steps of:
at said recipient, upon receiving said first dataset, checking said first dataset for authenticity generating an enable code as a second dataset;
at said recipient, cryptographically protecting said enable code with an electronic signature of said recipient and transmitting said dataset with said electronic signature from said recipient to said use location as a return message; and
at said use location, checking said enable code for authenticity be verifying said electronic signature.

4. A method as claimed in claim 3 comprising the additional steps, at said use location, of:
if said enable code is authentic, resetting said charge to zero; and
if said enable code is not authentic, inhibiting further usage of said commodity at said use location.

5. A method as claimed in claim 1 wherein the step of generating said electronic message comprises including said usage value and said time data in said electronic message together with said charge.

6. A method as claimed in claim 1 comprising the additional step of generating said usage value at an end of a predetermined time segment for use of said commodity.

7. A method as claimed in claim 6 comprising forming said time segment periodically.

8. A method as claimed in claim 6 comprising forming said time segment dependent on an event related to usage of said commodity.

9. A method as claimed in claim 1 comprising the additional steps of:
identifying an event related to generation of said charge;
upon an occurrence of said event, calculating said charge to obtain an event-related charge; and
storing said event-related charge together with the usage value that was employed to generate said event-related charge.

10. A method as claimed in claim 9 wherein the step of identifying said event comprises identifying a change of said rate value as said event.

11. A method as claimed in claim 9 wherein the step of identifying said event comprises identifying a change in said usage value relative to a predetermined reference.

12. A method as claimed in claim 1 comprising analyzing said use data to identify usage behavior at said use location.

13. A method as claimed in claim 1 comprising generating an authentification code as said check code.

14. A method as claimed in claim 13 comprising selecting said authentification code from the group consisting of a hash code and an MAC, and forming said authentification code according to a symmetrical encryption algorithm.

15. A usage counter for a commodity comprising:
an input and an output for a commodity;
a measured value generator connected to said input and said output for generating a measured value of said commodity;
a security housing containing a security module connected to said measured value generator, and at least one security detector which detects an attempt to breach said security module;
a non-volatile memory in said security module in which at least one monetary rate value for usage of said commodity is stored, said rate value being valid for a predetermined time span;
said security module calculating a monetary charge for said usage of said commodity from said measured value and said rate value;
a communication device connected to said security module for electronically transmitting said charge to a recipient at a location remote from said communication device; and
said security module generating an electronic reaction, indicating an attempt to fraudulently manipulate said charge, dependent on at least one of a status of said security detector and said measured value.

16. A usage counter as claimed in claim 15 wherein said security module, for generating said electronic reaction, monitors said measured value to determine whether said measured value generator has been disconnected.

17. A usage counter as claimed in claim 16 wherein said measured value is an analog signal, and further comprising an analog-to-digital converter supplied with said analog signal for converting said analog signal into a digital signal, and wherein said security module monitors said measured value by generating a count dependent on said digital signal.

18. A usage counter as claimed in claim 17 wherein said analog-to-digital converter is a component of said measured value generator.

19. A usage counter as claimed in claim 17 wherein said analog-to-digital converter is a component of said security module.

20. A usage counter as claimed in claim 15 wherein said security module includes a real-time counter and wherein said security module causes said communication device to electronically communicate said measured value to said recipient at regular times identified by said real-time counter.

21. A usage counter as claimed in claim 15 wherein said security module includes a real-time counter and wherein said security module calculates said monetary charge at a time determined by said real-time counter.

22. A usage counter as claimed in claim 15 wherein said communication device is an ISDN module adapted for connection to said recipient via a telephone network.

23. A usage counter as claimed in claim 15 wherein said communication device is a power line module adapted for communication with said recipient via an energy supply network.

24. A usage counter as claimed in claim 15 wherein said communication device is a blue tooth module adapted to wirelessly communicate with a further blue tooth module at said recipient.

25. A usage counter as claimed in claim 15 wherein said communication device comprises a first blue tooth module and a second blue tooth module in wireless communication with said first blue tooth module, said second blue tooth module being adapted for communication with said recipient via a telephone network.

26. A usage counter as claimed in claim 15 wherein said communication device is integrated in said security module.

27. A usage counter as claimed in claim 15 wherein said input is an input for an electronically represented postage value and wherein said output is an output for said electronically represented postage value.
